(19) United States
(12) Patent Application Publication
(10) Pub. No.: US 2004/0265160 A1
(43) Pub. Date: Dec. 30, 2004

(54) Cooled screw-type vacuum pump

(76) Inventors: Manfred Behling, Koln (DE); Hartmut Kriehn, Koln (DE); Klaus Rofall, Rosrath (DE); Ralf Steffens, Steinen (DE)

Correspondence Address: Fay Sharpe Fagan Minnich & McKee, 1100 Superior Avenue, Seventh Floor, Cleveland, OH, 44114-2518, US

(21) Appl. No.: 10/495,796

(22) PCT Filed: Oct. 30, 2002
(86) PCT No.: PCT/EP02/12086

(30) Foreign Application Priority Data
Nov. 15, 2001 (DE) 101 56 180.6

(51) Int. Cl. F03C 2/00; F01C 1/16

(52) U.S. Cl. 418/85; 418/94; 418/201.1

(57) ABSTRACT

A screw-type vacuum pump (1) includes a pump housing (2, 6) with rotors (3, 4). A liquid cooling system cools the rotors and a drive motor (9). In order to improve the cooling of said pump, an external air-flow impelled cooling system is also provided for the pump housing (2, 6).

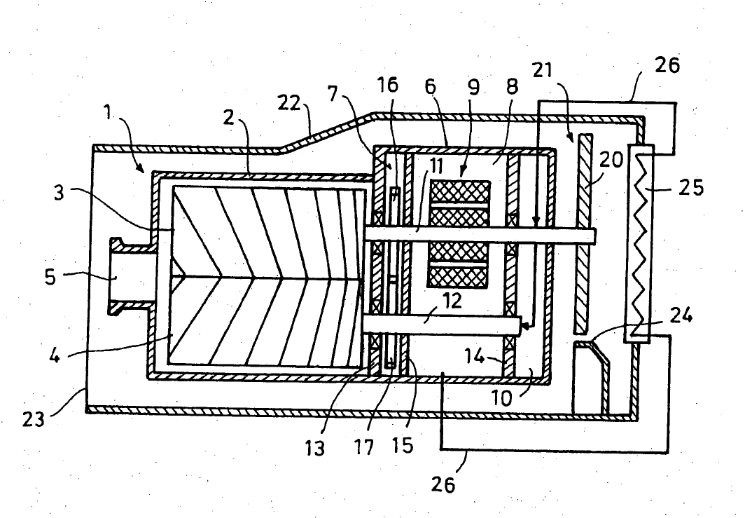

The invention relates to a screw-type vacuum pump comprising a pump housing with rotors arranged therein, a liquid cooling system for the rotors and a drive motor.

From DE-A-198 20 523 a screw-type vacuum pump with these characteristics is known. Said document discloses, moreover, the multiple problems involved in cooling screw-type vacuum pumps when these shall be built for, and operated at high performance densities—compact and operating at high rotational speeds.

It is the task of the present invention to improve the cooling system for a screw-type vacuum pump having the aforementioned characteristics. This task is solved through the present invention through the characterising features of the patent claims.

The additional cooling system in accordance with the present invention for cooling the pump housing from the outside, specifically by way of an impelled air flow produced by a fan linked to the motor, for example, considerably relieves the liquid cooling system for the rotors accommodated within the pump of stress. In addition, it is possible with the aid of the impelled air flow to also cool a heat exchanger through which the cooling liquid of the rotor cooling system flows.

The present invention allows the implementation of a cooling concept for a screw-type vacuum pump in which the entire machine is air cooled although in addition a liquid cooling system for the rotors is present. The produced heat is in fact dissipated by two different heat carriers (liquid for the inner rotor cooling system, outer cooling air flow) finally the heat, however, is in total dissipated by the cooling air flow. This also applies to the dissipation of secondary heat flows produced by motor losses, gear and bearing losses etc.

Further advantages and details of the present invention shall be explained with reference to an embodiment depicted schematically in the drawing FIGURE.

In the drawing FIGURE, the screw-type vacuum pump which is to be cooled is designated as 1, its pump chamber housing with 2, its rotors with 3, 4, its inlet with 5 and the gear/motor chamber housing with 6, the latter being adjacent with respect to the pump chamber housing 2 with the rotors 3, 4. An outlet on the delivery side is not depicted. Accommodated in the housing 6 is the gear chamber 7, the motor chamber 8 with the drive motor 9 and a further chamber 10, being a component of the liquid cooling circuit for the rotors 3, 4.

The rotors 3, 4 are equipped with shafts 11, 12 which penetrate the gear chamber 7 and the motor chamber 8. Through bearings in the separating walls between pump chamber and gear chamber 7 (separating wall 13) as well as motor chamber 8 and cooling liquid chamber 10 (separating wall 14), the rotors 3, 4 are suspended in a cantilevered manner. The separating wall between gear chamber 7 and motor chamber 8 is designated as 15. Accommodated in the gear chamber 7 is a pair of toothed wheels 16, 17 effecting the synchronous rotation of the rotors 3, 4. The rotor shaft 11 is simultaneously the drive shaft of the motor 9. The motor 9 may even be equipped with a drive shaft differing from the shafts 11, 12. In the instance of such a solution its drive shaft terminates in gear chamber 7 and is equipped there with a toothed wheel which intermeshes with one of the synchronising toothed wheels 16, 17 (or a further toothed wheel, not depicted, of the shaft 12).

Shaft 11 penetrates the chamber 10, is run out of the housing 6 of the pump 1 and carriers at its unoccupied end the wheel 20 of a ventilator or fan 21. A housing 22 encompassing the pump 1 serves the purpose of guiding the air movement produced by blade wheel 20, said housing being open (apertures 23, 24) in the area of both face sides.

In the sense of the present invention, the fan 21 is operated such that the aperture 24 on the fan/motor side forms the air inlet aperture. Assigned to this aperture is a heat exchanger 25 through which the cooling liquid of the internal rotor cooling system flows. Expediently, the heat exchanger 25 is located upstream of fan 21 so that it simultaneously forms a means of touch protection for the blade wheel 20. The advantage of this arrangement is, that the air flow cooling the pump chamber housing 2 of the pump 1 is pre-warmed. In this manner it is achieved that thermal expansions of the pump chamber housing 2 are allowed to such an extent that the rotors 3, 4 attaining during operation of pump 1 relatively high temperatures, do not come into contact with the housing 2. Preferably, the housing 2 and the rotors 3, 4 are made of aluminium for the purpose of improving heat conductance. Moreover, the housing 2 may exhibit fins for improving the thermal contact. Through the size of the heat exchanger 25 and also through the degree by which the pump chamber housing 2 is equipped with fins, the gap between the rotors 3, 4 and the housing 2 is adjusted.

The cooling liquid circuit for cooling the rotors 3, 4¹) is depicted only schematically. In the German patent applications 197 45 616, 199 63 171.9 and 199 63 172.7 cooling systems of this kind are described in detail. The shafts 11 and 12 serve the purpose of conveying the coolant (oil, for example) to and from the rotors 3, 4. In the example of the depicted embodiment, the coolant exiting the rotors 3, 4 collects in the motor chamber 8. From there the coolant is supplied through the line 26 to the heat exchanger 25. The air flow produced by fan 21 dissipates the heat which was dissipated by the cooling liquid in the rotors 3, 4. The liquid exiting the heat exchanger 25 is supplied through the line 26 to the chamber 10. In a manner not depicted in detail it passes from there through bores in the shafts 11, 12 to the rotors 3, 4, flows there through cooling ducts and passes through the shafts 11, 12 back into the motor chamber 8. ¹⁾ Translator's note: The German text states “4, 5” here whereas “3, 4” would be more in line with the drawing FIGURES and the remainder of the text. Therefore “3, 4” has been assumed for the translation.

It has been found to be expedient to adjust the cooling system such that approximately half of the heat generated by the pump is first dissipated by the cooling liquid and thereafter removed through the heat exchanger 25, and such that the other half is dissipated directly by the cooling air flow.)

In all, the characteristics in accordance with the present invention allow a further increase in the performance density of a screw-type pump. The pump may be designed to be smaller and may be operated at higher surface temperatures.

The housing 22 serving the purpose of guiding the outer air flow has, in addition, the function of providing a means of touch protection.

1. A screw-type vacuum pump comprising:
a pump housing with rotors arranged therein;
a liquid cooling system for the rotors;
a drive motor; and
an external air-flow impelled cooling system for the pump housing.

2. The pump according to claim 1, wherein for the impelled airflow cooling system includes:
a fan linked to the drive motor.

3. The pump according to claim 2, wherein the fan, the drive motor and the pump housing are arranged sequentially in a direction of the flow.

4. The pump according to claim 3, wherein at least the pump housing is equipped with outer fins.

5. The pump according to claim 1, wherein the housing and the rotors are constructed of aluminum.

6. The pump according to claim 1, further including:
an outer housing for guiding the cooling air.

7. The pump according to claim 6, wherein the fan is located adjacent an air inlet side of the outer housing.

8. The pump according to claim 1, further including:
a heat exchanger through which a cooling liquid of the liquid cooling system flows.

9. The pump according to claim 2, wherein the heat exchanger is located in a cooling air flow upstream of the fan.

10. The pump according to claim 1, wherein the liquid cooling system is designed such that a quantity of heat dissipated directly by an air flow of the air-flow impelled cooling system, are approximately equal.

11. A screw-type vacuum pump comprising:
an inner pump housing;
a pair of rotors rotatably mounted in the inner pump housing;
a drive motor mounted in the inner pump housing;
an outer housing displaced from the inner pump housing to define a passage for cooling air therebetween, such that cooling air flowing between the inner and outer housings removes heat from the rotors and drive motor;
a liquid cooling system for circulating a cooling liquid for cooling the drive motor and the rotors.

12. The pump according to claim 11 further including a fan mounted in the outer housing for propelling air through the air cooling passage between the inner and outer housings.

13. The pump according to claim 12 wherein the liquid cooling system includes:
a heat exchanger mounted to the outer housing adjacent the fan such that the fan moves air both through the air cooling passage and through the heat exchanger.

14. The pump according to claim 13 wherein the heat exchanger and the cooling air passage are sized such that a substantially equal amount of heat is removed from the rotors by air flowing through the cooling air passage and half of the heat is removed from the rotors by liquid coolant circulating through the liquid cooling system.
